(19) United States
(12) Patent Application Publication
(10) Pub. No.: US 2007/0273268 A1
(43) Pub. Date: Nov. 29, 2007

(54) Planar Image Display Device and Manufacturing Method Thereof

(76) Inventors: Toshio Tojo, Ichinomiya (JP); Nobuyasu Hayashi, Chonan (JP); Katsuyuu Takahashi, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/620,131

(22) Filed: Jan. 5, 2007

(30) Foreign Application Priority Data
Jan. 6, 2006 (JP) 2006-001725

(51) Int. Cl. H01J 63/04; H01J 1/62

(52) U.S. Cl. 313/496

(57) ABSTRACT

The present invention provides a display device which arranges a face substrate having a phosphor screen and a back substrate having electrons sources in a matrix array, wherein an average film density of the phosphor film which constitutes the phosphor screen is set to a value which falls within a range from 2.0 g/cm² to 3.4 g/cm². Due to such a constitution, it is possible to achieve the high brightness and the prolonged lifetime of the phosphor screen of the planar image display device.

### BACKGROUND OF THE INVENTION

1. Field of the Invention

The present invention relates to a planar image display device which makes use of emission of electrons into vacuum formed between a face substrate and a back substrate and a manufacturing method thereof.

2. Description of the Related Art

A color cathode ray tube has been popularly used conventionally as an excellent display device which exhibits high brightness and high definition. However, along with the realization of high image quality of recent information processing device and television broadcasting, there has been a strong demand for a planar image display device (flat panel display, FPD) which is light-weighted and requires a small space for installation while ensuring the excellent properties such as high brightness and high definition.

As typical examples of such a planar image display device, a liquid crystal display device, a plasma display device or the like has been put into practice. Further, particularly with respect to the planar display device which can realize the high brightness, various planar image display devices such as a self luminous display device which makes use of emission of electrons into vacuum from electron sources, for example, an electron emitting type planar image display device, a field emitting type planar image display device, or an organic EL display which is characterized by low power consumption are expected to be put into practice in near future.

Among these planar image display devices, with respect to the self-luminous flat panel display, there has been known a display device having the constitution in which electron sources are arranged in a matrix array, wherein as one such display, there has been also known the above-mentioned electron emitting type planar image display device which makes use of minute and integrative cold cathodes.

Further, in the self-luminous flat panel display, as cold cathodes, thin film electron sources of a Spindt type, a surface conduction type, a carbon nanotubes type, an MIM (Metal-Insulator-Metal) type which laminates a metal layer, an insulator and a metal layer, an MIS (Metal-Insulator-Semiconductor) type which laminates a metal layer, an insulator and a semiconductor layer, a metal-insulator-semiconductor-metal type or the like has been used.

With respect to the MIM type electron source, there has been known an electron source which is disclosed in Japanese Patent Laid-open Hei7(1995)-65710 (patent document 1) and Japanese Patent Laid-open Hei10 (1998)-153979 (patent document 2), for example. Further, with respect to the metal-insulator-semiconductor type electron source, there has been known an MOS type electron source reported in j. Vac. Sci. Techonol. B11(2) p. 429-432 (1993) (non-patent document 1). Further, with respect to the metal-insulator-semiconductor-metal type electron source, there has been known a HEED type electron source reported in high-efficiency-electro-emission device, Jpn. J. Appl. Phys., vol36, pL939 (non-patent document 2), an EL type electron source reported in Electroluminescence, Applied Physics, Volume 63, No. 6, p. 592 (non-patent document 3), or a porous silicon type electron source reported in Applied Physics, Volume 66, No. 5, p. 437 (non-patent document 4).

In the electron emitting type FPD, a back substrate having the above-mentioned electron sources and a face substrate which includes phosphor layers and anodes which form accelerating voltage for allowing electrons emitted from the electron sources to impinge on the phosphor layers are arranged in a state that the back substrate and the face substrate face each other in an opposed manner. A sealing frame body is arranged between both substrates and a hermetically sealed space is defined by the face substrate, the back substrate and the sealing frame body. Gas in the inside of the hermetically sealed space is discharged. The display device is operated by combining a drive circuit to the display panel.

The electron emitting type planar image display device includes a back substrate which has a large number of first lines (for example, cathode lines, image signal lines) which extend in the first direction and are arranged in parallel in the second direction which intersects the first direction, an insulation film which is formed in a state that the insulation film covers the first lines, a large number of second lines (for example, gate lines, scanning signal lines) which extend in the second direction and are arranged in parallel in the first direction over the insulation film, and electron sources which are provided in the vicinity of intersecting portions of the first lines and the second lines. The back substrate includes a substrate made of an insulating material and the above-mentioned lines are formed on the substrate.

In such a constitution, a scanning signal is sequentially applied to the scanning signal lines. Further, on the substrate, connection lines which connect the scanning signal line and the image signal line with the electron sources are provided for supplying an electric current to the electron sources. A face substrate is arranged to face the back substrate in an opposed manner, wherein phosphor layers of plural colors and the anode are formed on an inner surface of the face substrate which faces the back substrate in an opposed manner. The face substrate is made of a light-transmitting material which is preferably glass. Further, both substrates are sealed by inserting a sealing frame body between laminating inner peripheries of both substrates, and the inner space which is defined by the back substrate, the face substrate and the sealing frame body is evacuated into vacuum thus constituting the image display device.

The electron sources are positioned in the vicinities of the intersecting portions of the first line and the second line as mentioned above. An emission quantity of electrons from the electron source (including the turning on and off of the emission) is controlled based on a potential difference between the first electrode and the second electrode. The emitted electrons are accelerated due to a high voltage applied to the anode formed on the face substrate and, as disclosed in Japanese Patent Laid-open 2003-197135 (patent document 3), impinge on phosphor layers formed on the face substrate thus exciting the phosphor layers and the light of colors corresponding to light emitting characteristics of the phosphor layers are generated.

The individual electron source forms a pair with a corresponding phosphor layer so as to constitute a unit pixel. Usually, one pixel (color pixel) is constituted of the unit pixels of three colors consisting of red (R), green (G) and blue (B). Here, in the case of the color pixel, the unit pixel is also referred to as a sub pixel.

In the planner image display device described above, in general, in the inside of a hermetically sealed space which is arranged between the back substrate and the face substrate and is surrounded by the frame body, a plurality of distance holding members (hereinafter referred to as spacers) is arranged and fixed. The distance between the above-mentioned both substrates is held at a predetermined distance in cooperation with the frame body. The spacers are formed of a plate-like body which is made of an insulating material such as glass, ceramics or the like, in general. Usually, the spacers are arranged at positions which do not impede an operation of pixels for every plurality of pixels.

Further, the sealing frame body is fixed to inner peripheries of the back substrate and the face substrate using a sealing material such as frit glass, and the fixing portions are hermetically sealed. The degree of vacuum in the inside of a space defined by both substrates and the frame body is set to a value which falls within a range from 10⁻⁵ to 10⁻⁷ Torr, for example.

The first lines and the second lines which are formed on the back substrate penetrate the sealing regions defined by the frame body and the substrates, and distal end portions of the first and second lines include first line lead terminals and second line lead terminals respectively.

### SUMMARY OF THE INVENTION

In a planar image display device having the constitution as disclosed in patent document 3, electron beams which are emitted from the electron sources arranged on the back substrate side are accelerated and are impinged on phosphor layers formed on the face substrate thus exciting the phosphor layers and the lights of colors corresponding to light emitting characteristics of the phosphor layers are generated. The light emitting principle of the planar image display device is as same as the light emitting principle of the color cathode ray tube.

On the other hand, in the planar image display device having the constitution as disclosed in the patent document 3, the acceleration voltage is set to approximately 10 kV or less and the voltage is approximately several fractions compared to the acceleration voltage of approximately 30 kV of the above-mentioned color cathode ray tube. The difference in the acceleration voltage brings about a tendency that intrusion distance of the electron beams into the phosphor layer becomes short and charging applied to a surface of the phosphor particles is easily increased and hence, the brightness of the phosphor screen is lowered and the lifetime of the phosphor particles is lowered.

It is an object of the present invention to provide a highly reliable planar image display device having a high brightness which can prevent lowering of the brightness of a phosphor screen and the decrease of the lifetime of phosphor particles and can possess a prolonged lifetime.

To achieve the above-mentioned object, according to the present invention, in a planar image display device which arranges a BM film, phosphor layers and a metal back on one of substrates which face each other in an opposed manner and includes electron sources which are arranged on another substrate in a matrix array, average film density of the phosphor layer is set to a value which falls within a rage from 2.0 g/cm³ to 3.4 g/cm³. By incorporating an image signal drive circuit, a scanning signal drive circuit and other peripheral circuits into the planar image display device having such a constitution, a self-luminous planar display device is constituted.

Electron-beam utilization efficiency can be enhanced by highly densifying the phosphor layers and hence, light is allowed to be emitted from the whole phosphor layers thus realizing the high brightness of a phosphor screen whereby a planar display device having high brightness and a prolonged life time can be acquired. Further, the degradation of phosphor particles is prevented by reducing charging of the phosphor particles and hence, the high brightness and a prolonged life time of the phosphor screen can be achieved whereby a planar display device having high brightness and a prolonged life time can be acquired. Further, it is also possible to acquire a planar image display device having high brightness and a prolonged life time by preventing the degradation of substrates attributed to electron beams.

### BRIEF DESCRIPTION OF THE DRAWINGS

FIG. 1A and FIG. 1B are views for explaining one embodiment of a planar image display device of the present invention, wherein FIG. 1A is a view as viewed from a face substrate side, and FIG. 1B is a side view of the planar image display device shown in FIG. 1A;

FIG. 2 is a schematic plan view of the planar image display device taken along a line A-A in FIG. 1B;

FIG. 3 is a schematic cross-sectional view of the back substrate taken along a line B-B in FIG. 2 and a schematic cross-sectional view of the face substrate at a portion corresponding to the back substrate;

FIG. 4 is a partially enlarged schematic cross-sectional view of a phosphor screen shown in FIG. 3;

FIG. 5 is a partially enlarged schematic cross-sectional view of FIG. 4;

FIG. 6 is a view showing a relationship between average film density and a brightness ratio of a phosphor layer;

FIG. 7 is a schematic view showing the number of phosphor particle layers and an arrangement shape;

FIG. 8 is a view showing a relationship between the number of layers and a brightness ratio of the phosphor particles;

FIG. 9 is a view showing a relationship between a phosphor particle size and a brightness ratio;

FIG. 10 is a flow chart for explaining a manufacturing method of the planar image display device according to the present invention;

FIG. 11A, FIG. 11B and FIG. 11C are views of electron sources of the planar image display device of the present invention, wherein FIG. 11A is a plan view, FIG. 11B is a cross-sectional view taken along a line C-C in FIG. 11A, and FIG. 11C is a cross-sectional view taken along a line D-D in FIG. 11A; and

FIG. 12 is an explanatory view of an equivalent circuit example of the planar image display device to which the constitution of the present invention is applied.

### DESCRIPTION OF THE PREFERRED EMBODIMENTS

Hereinafter, embodiments of the present invention are explained in detail in conjunction with drawings.

### Embodiment 1

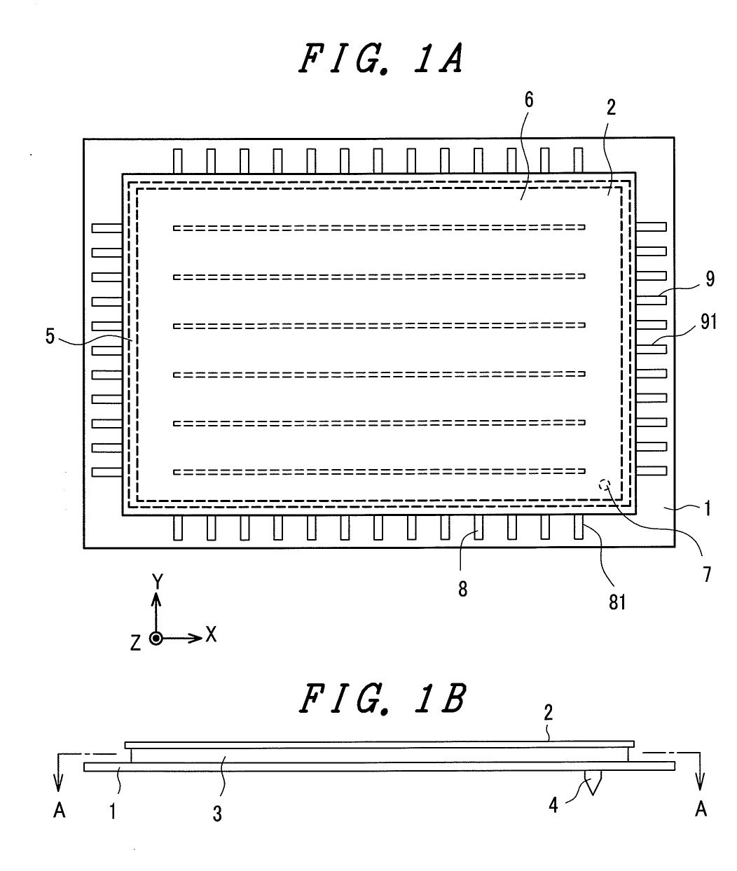

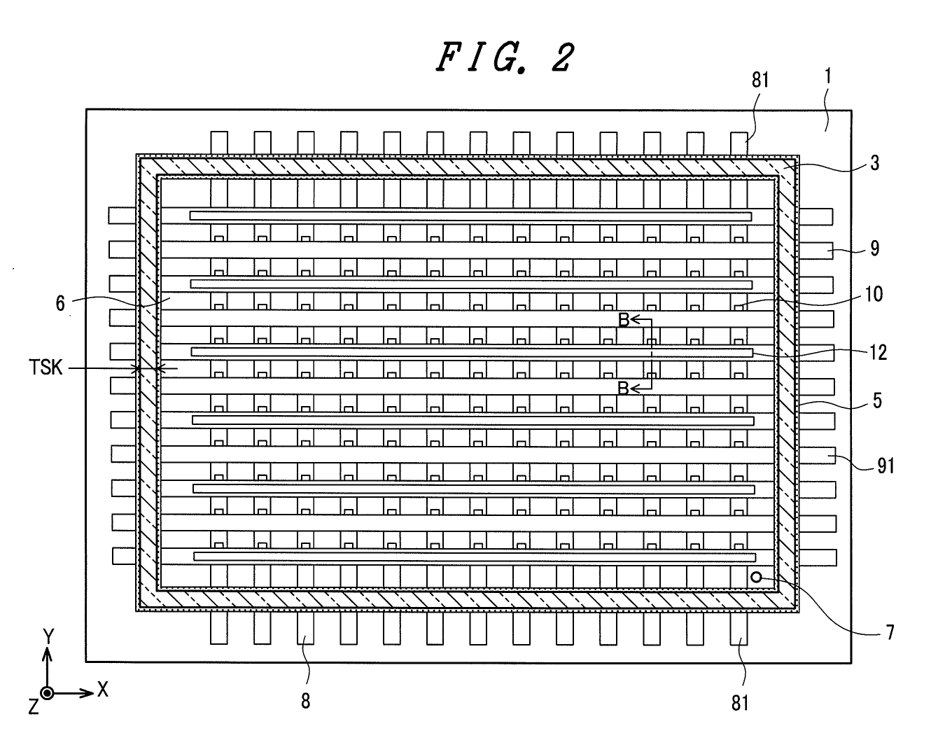

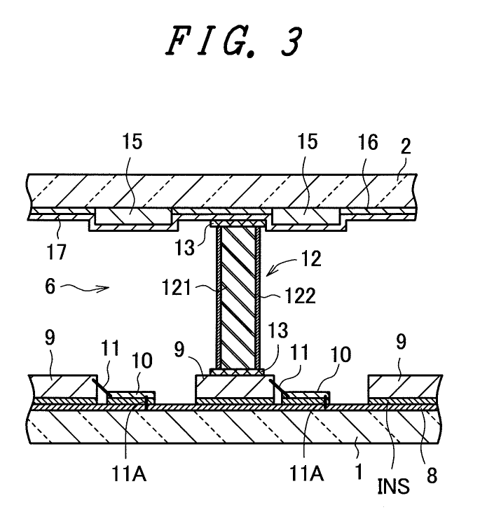

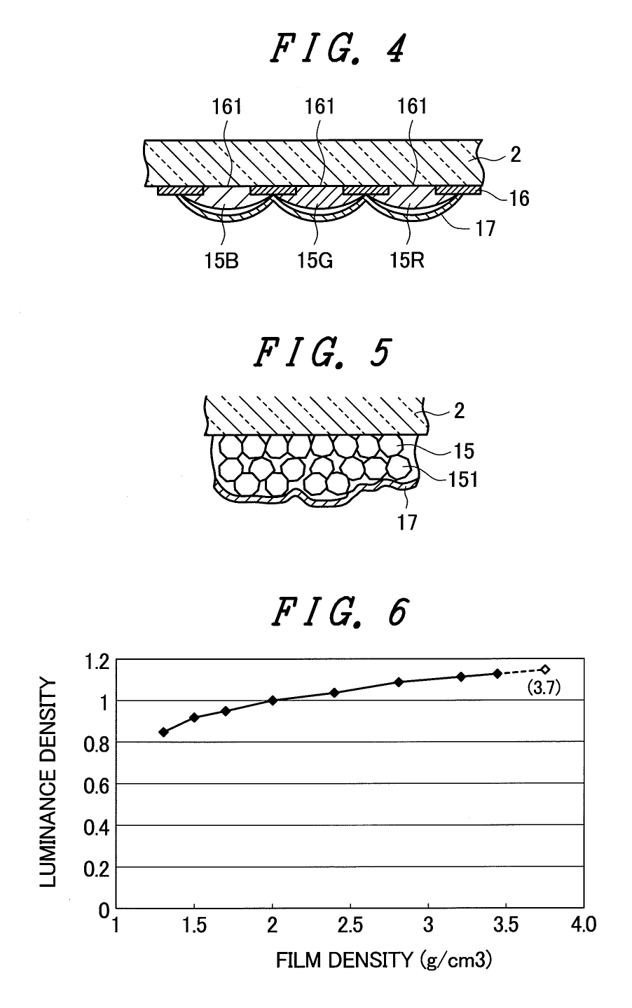

FIG. 1 to FIG. 5 are views for explaining one embodiment of a planar image display device according to the present invention. FIG. 1A is a plan view as viewed from a face substrate side, FIG. 1B is a side view of FIG. 1A, FIG. 2 is a schematic plan view taken along a line A-A in FIG. 1B, FIG. 3 is a schematic cross-sectional view of a back substrate taken along a line B-B in FIG. 2 and a schematic cross-sectional view of a portion of the face substrate which corresponds to the back substrate, FIG. 4 is a partially enlarged schematic cross-sectional view of the phosphor screen of FIG. 3, and FIG. 5 is a partially enlarged schematic cross-sectional view showing one portion of the phosphor screen of FIG. 4.

In these FIG. 1 to FIG. 5, numeral 1 indicates a back substrate and numeral 2 indicates a face substrate, wherein both substrates 1, 2 are formed of a glass plate having a thickness of several mm, for example, approximately 1 to 10 mm. Both substrates are formed in a substantially rectangular shape. The back substrate and the face substrate are stacked with a predetermined distance therebetween. Numeral 3 indicates a sealing frame body which has a frame-like shape. The frame body 3 is formed of, for example, a frit glass sintered body, a glass plate or the like. The frame body 3 is formed by a single body or by a combination of a plurality of members and is formed in a substantially rectangular shape. Further, the frame body 3 is interposed between the above-mentioned both substrates 1, 2.

The frame body 3 is interposed between both substrates 1, 2 and has both end surfaces hermetically adhered to both substrates 1, 2. A thickness TSK of this frame body 3 is set to a value which falls within a range from several mm to several tens mm, and a height thereof is set to a size substantially equal to a distance between both substrates 1, 2. Numeral 4 indicates an exhaust pipe. The exhaust pipe 4 is fixedly mounted on the back substrate 1. Further, numeral 5 indicates a sealing material. The sealing material 5 is made of frit glass, for example, and joins the frame body 3 and both substrates 1, 2 thus hermetically sealing the space defined by the frame body 3 and both substrates 1, 2.

The space 6 which is a space surrounded by the frame body 3, both substrates 1, 2 and the sealing material 5 is evacuated through the exhaust pipe 4 thus holding a degree of vacuum of, for example, 10⁻⁵ to 10⁻⁷ Torr. Further, the exhaust pipe 4 is mounted on an outer surface of the back substrate 1 as mentioned previously and is communicated with a through hole 7 which is formed in the back substrate 1 in a penetrating manner. After completing the evacuation, the exhaust pipe 4 is sealed.

Numeral 8 indicates video signal lines and these video signal lines 8 extend in one direction (Y direction) and are arranged in parallel in another direction (X direction) on an inner surface of the back substrate 1. These video signal lines 8 hermetically penetrate a connection region between the frame body 3 and the back substrate 1 from the space 6 and extend to a long-side side end portion of the back substrate 1, and the video signal lines 8 have distal end portions thereof formed into video signal line lead terminals 81.

Numeral 9 indicates scanning signal lines. The scanning signal lines 9 extend over the video signal lines 8 in the above-mentioned another direction (X direction) which intersects the video signal lines 8 and are arranged in parallel in the above-mentioned one direction (Y direction). These scanning signal lines 9 hermetically penetrate a connection region between the frame body 3 and the back substrate 1 from the space 6 and extend to a short-side side end portion of the back substrate 1. Further, distal end portions of the scanning signal lines 9 constitute scanning signal line lead terminals 91.

Numeral 10 indicates electron sources and the electron sources 10 are formed in the vicinity of respective intersecting portions of the scanning signal lines 9 and the video signal lines 8. The electron sources 10 are connected with the scanning signal lines 9 and the video signal lines 8 via connection lines 11, 11A respectively. Further, interlayer insulation films INS are arranged between the video signal lines 8, the electron sources 10 and the scanning signal lines 9.

Here, the video signal lines 8 are formed of an Al (aluminum) film, for example, while the scanning signal lines 9 are formed of a Cr/Al/Cr film, a Cr/Cu/Cr film or the like, for example. Further, although the above-mentioned line lead terminals 81, 91 are provided to both ends of the electrodes, the line lead terminals 81, 91 may be provided to only either one of these ends.

Next, numeral 12 indicates spacers, wherein the spacers 12 are made of an insulation material such as a ceramic material or the like and are constituted of an insulation base body 121 which exhibits the small fluctuation of resistance value and is shaped in a rectangular thin plate shape and a covered layer 122 which covers the surface of this insulation base body 121 and exhibits the small fluctuation of resistance value. The spacer 12 possesses a resistance value of approximately 10⁸ to 10⁹ Ω·cm and has a constitution which exhibits the small fluctuation of resistance value as a whole.

The spacers 12 are arranged above the scanning signal lines 9 every one other line substantially parallel to the above-mentioned frame body 3 in an erected manner, and are fixed to both substrates 1, 2 using an adhesive material 13. The fixing of the spacers 12 to the substrates using the adhesive material 13 may be applied to only one end side of the spacers 12. Further, with respect to the arrangement of the spacers 12, the spacers 12 are usually arranged at positions where the spacers 12 do not impede the operations of the pixels for every plurality of other pixels.

Sizes of the spacers 12 are set based on sizes of substrates, a height of the frame body 3, materials of the substrates, an arrangement interval of the spacers, a material of spacers and the like. However, in general, the height of the spacers is approximately equal to a height of the above-mentioned frame body 3. A thickness of the spacer 12 is set to several 10 μm to several mm or less, while a length is set to a value which falls within a range from approximately 20 mm to 1000 mm. Preferably, a practical value of the length is set to a value which falls within a range from approximately 80 mm to 120 mm.

In an inner surface of the face substrate 2 to which one end sides of the spacers 12 are fixed, phosphor layers 15 of red, green and blue are arranged in a state that these phosphor layers 15 are defined by a light-shielding BM (black matrix) film 16. A metal back (an anode electrode) 17 made of a metal thin film is formed in a state that the metal back 17 covers the phosphor layers 15 and the BM film 16 by a vapor deposition method thus forming a phosphor screen.

Further, with respect to these phosphors, for example, Y₂O₃:Eu, Y₂O₂S:Eu may be used as the red phosphor, ZnS:Cu,A₁, Y₂SiO₅:Tb may be used as the green phosphor and, further, ZnS:Ag,Cl, ZnS:Ag,Al or the like may be used as the blue phosphor.

The constitution of the phosphor screen is explained in further detail in conjunction with FIG. 4 and FIG. 5. The black matrix film 16 is formed on an inner surface of the face substrate 2 while forming a plurality of window portions 161 therein. Green phosphor layers 15G, blue phosphor layers 15B and red phosphor layers 15R are respectively arranged in a state that these phosphor layers 15G, 15B and 15R cover the window portions 161 of the black matrix film 16 and extend over portions of a back surface of the face substrate 2. Further, a metal back 17 is formed on back surfaces of the phosphor layers 15 as a film.

An average film density of the phosphor layers 15 is set to a value which falls within a range from 2.0 g/cm³ to 3.4 g/cm³, and an average particle size of phosphor particles 151 in the phosphor layers 15 is set to a value which falls within a range from 4 μm to 9 μm. Further, a film thickness of the phosphor layer 15 is set to a value which falls within a range from 10 μm to 20 μm or is set to a value 1.8 to 3.0 times as large as the average particle size of the phosphor particles 151. Further, the phosphor layers 15G to 15R of respective colors use phosphor particles having true density which falls within a range from 4.0 g/cm³ to 5.1 g/cm³ as the phosphor particles 151.

With respect to true density of the red phosphor particles 151, the true density of Y₂O₃:Eu is set to 5.1 g/cm³ and Y₂O₂S:Eu is set to 4.9 g/cm³. With respect to true density of the green phosphor 151, the true density of ZnS:Cu,Al is set to 4.1 g/cm³ and Y₂SiO₅: Tb is set to 4.6 g/cm³. Further, with respect to true density of the blue phosphor 151, the true densities of ZnS:Ag,Cl and ZnS:Ag,Al are equally set to 4.1 g/cm³. These phosphors are used for the phosphor layers 15.

Electrons radiated to the phosphor screen from the above-mentioned electron source 10 are accelerated and are made to impinge on the phosphor layer 15 which constitutes the corresponding pixel. Due to such a constitution, the phosphor layer 15 emits light of predetermined color, and the light is mixed with emitted light of color of the phosphor of another pixel thus constituting the color pixel of predetermined color. The increase of this emitted-light takeout efficiency is important for enhancing the brightness of the image display device.

Further, the metal back 17 has a function as a light reflection film for increasing emitted-light takeout efficiency by reflecting light emitted to a side opposite to the face substrate 2, that is, to the back substrate 1 side toward the face substrate 2 side and, as well as, a function of preventing charging of the surface of the phosphor particles 151. Further, although the metal back 17 is indicated as a surface electrode, the metal back 17 may be formed of stripe-like electrodes which are divided for respective pixel columns while intersecting the scanning signal lines 9.

FIG. 6 is a view showing the relationship between an average film density and a brightness ratio of the phosphor layer 15 (luminance density), and shows numerical values when the phosphor layer having a film thickness of 15 μm is operated at an acceleration voltage of 7 kV using the phosphor having an average particle size which falls within a range from 4 μm to 9 μm and a true density having a value which falls within a range from 4.0 g/cm³ to 5.1 g/cm³. As can be clearly understood from FIG. 6, with respect to a low-density film having an average film density of less than 2.0 g/cm³, electron beams impinge on the phosphor particles thus generating a multiple reflection due to elastic scattering or non-elastic scattering and hence, an amount of energy absorbed in the face substrate 2 cannot be ignored whereby it is difficult to obtain the high brightness.

On the other hand, with respect to a high-density film having an average film density exceeding 2.0 g/cm³, although electron beams impinge on the phosphor particles thus generating multiple reflection due to elastic scattering or non-elastic scattering in the same manner as the above-mentioned low-density film, most of reflected electrons are used for the emission of light from the phosphors again and hence, it is possible to obtain the high brightness. Further, when the electron beams impinge on the phosphor layer, there is observed a phenomenon that surfaces of the phosphor particles are charged thus easily lowering the brightness.

The high-density film includes a large number of contact points between the phosphor particles and the metal back compared to the low-density film thus forming the film structure which can easily discharge and hence, it is possible to prevent the lowering of the brightness attributed to charging. Further, due to the impingement of the electron beams, some electron beams are transformed into generated heat energy and hence, a temperature of the phosphor particles is increased thus lowering the brightness.

The display device adopts the means which avoids the lowering of brightness by radiating the heat energy to the face substrate due to heat conduction and thermal radiation of the phosphor particles thus preventing the elevation of temperature. However, with respect to the low-density film having the average film density of less than 2.0 g/cm³, there has been a drawback that the number of contact points between the phosphor particles is small and hence, the heat radiation cannot be expected by the heat conduction whereby the avoidance of the lowering of brightness totally depends on the heat radiation attributed to the thermal radiation. Accordingly, the suppression of the elevation of temperature is limited thus making it difficult to avoid the lowering of the brightness.

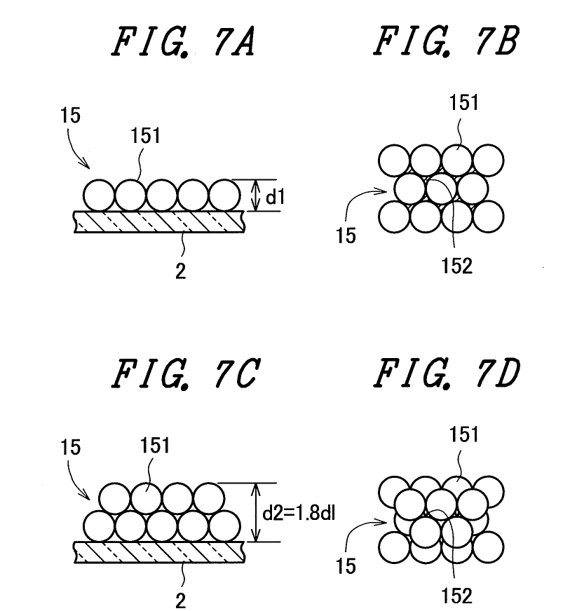

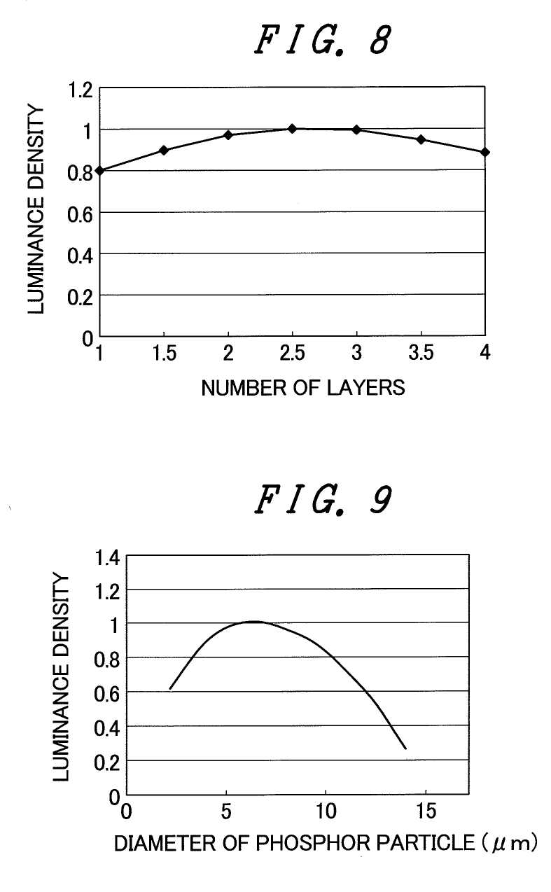

To the contrary, with respect to the high-density film having the average film density exceeding 2.0 g/cm³ and equal to or less than 3.4 g/cm³, the number of contact points among the phosphor particles is large compared to the above-mentioned low-density film thus forming a heat radiation mechanism which is the combination of the heat conduction and the thermal radiation. Accordingly, the heat radiation performance is enhanced thus suppressing the elevation of temperature thus avoiding the lowering of brightness attributed to the generated heat. This advantageous effect is explained in further detail in conjunction with FIG. 7 and FIG. 8.

FIG. 7A to FIG. 7D are schematic views showing the number of a phosphor particle layer and an arrangement shape of phosphor layers, wherein FIG. 7A is a view showing an arrangement shape of a first layer film, FIG. 7B is a view showing a cross section of a first layer film, FIG. 7C is a view showing an arrangement shape of phosphor layers of a second layer film, and FIG. 7D is a view showing a cross section of a second layer film. FIG. 8 is a view showing the relationship between the number of layers and brightness ratio of the phosphor particles, wherein a phosphor having an average particle size which falls within a range from 4 μm to 9 μm and a true density which falls within a range from 4.0 g/cm³ to 5.1 g/cm³ is used, and a numerical values of a case that the phosphor layer is operated at an acceleration voltage of 7 kV are shown.

First of all, in forming the phosphor layer, the phosphor particles 151 having the uniform particle size shown in FIG. 7A are arranged on an inner surface of the face substrate 2 by one layer and, in the observation of the phosphor particles 151 from the back substrate side as shown in FIG. 7B, it is confirmed that gap portions 152 which expose an inner surface of the face substrate 2 are spotted between the phosphor particles 151. A total area of the gap portions 152 amounts to approximately 10% of the whole surface. This area ratio is constant irrespective of particle sizes provided that the average particle size of the phosphor particles 151 is uniform. In such a state, electrons which do not directly impinge on the phosphor particles 151 amount to approximately 10% and hence, the lowering of the brightness is unavoidable.

Further, the phosphor particles are brought into a point contact state with neighboring phosphor particles. Accordingly, the heat radiation due to the heat conduction is hardly expected and the heat radiation is performed only through the thermal radiation and hence, the lowering of brightness attributed to the elevation of temperature of the phosphor particles cannot be avoided.

To overcome the lowering of brightness attributed to these causes, the above-mentioned gap portions 152 may be reduced or totally eliminated. For this end, as shown in FIG. 7C and FIG. 7D, above the phosphor particles 151 of one layer (of a back surface side), the phosphor particles 151 are overlapped at a position where the phosphor particles 151 are made stable thus forming a two-or-more-layered film and hence, an area ratio of the gap portions 152 can be set to 1% or less of the whole surface, or a contact area of the phosphor particles 151 with neighboring phosphor particles 151 can be increased compared to an one-layered film. Accordingly, the heat conductivity is increased.

On the other hand, a film thickness d2 of the two-layered film, because the phosphor particles 151 of the upper layer are arranged between the phosphor particles 151 of lower layer, becomes approximately 1.8 times (1.8d1) as large as the particle size d1 of the phosphors. This relationship is established even when a multi-layered film is formed of the phosphor particles 151. When the number of layers becomes two or more, the gap portions 152 are almost eliminated and hence, the probability that the electron beams directly impinge on the face substrate can be set to approximately 0% whereby a brightness ratio can be enhanced.

Due to such overlapping of the phosphor particles, the brightness ratio becomes a value which is close to approximately 1 as shown in FIG. 8 in the second layer film, for example and hence, the brightness ratio can be enhanced by approximately 0.2% compared to one-layered film. With the further increase of the number of layers, the gap portions 152 are completely eliminated and the enhancement of the brightness can be expected. However, when the number of layers becomes approximately four or more, the intrusion of the electron beams is interrupted and hence, it is impossible to allow the lower layer of the phosphor layer in the vicinity of the face substrate to emit light with the electron beams thus giving rise to a tendency that the optical transmissivity is lowered which becomes a cause of the lowering of the brightness. Accordingly, it is preferable to set the number of layers to approximately 2.0 to 3.5.

In this manner, the high-density film having the multi-layered structure can acquire the enhancement of brightness and the prolonged lifetime. However, when an average film density of the high-density film exceeds 3.4 g/cm³, there appears a tendency that the practicality is lowered technically as well as economically. This is because that although, for example, the red phosphor Y₂O₃:Eu, the green phosphor Y₂SiO₅:Tb, and the blue phosphor ZnS:Ag,Al respectively have the true densities of 5.1 g/cm³, 4.6 g/cm³ and 4.1 g/cm³, when these three kinds of phosphors are formed of phosphor particles having the uniform particle size distribution and form the densest film structure, a theoretical value of the average film density becomes 3.7 g/cm³.

It is estimated that the closer the average film density approaches this theoretical value, the high density film is obtained and hence, the high brightness is obtained. However, from a viewpoint of difficulty in acquisition of phosphors having the uniform particle size distribution and a film manufacturing technique, the maximum average film density of 3.4 g/cm³ is a value which is desirably technically as well as economically.

FIG. 9 is a view showing the relationship between the phosphor particle size and the brightness ratio of the phosphor layer 15. FIG. 9 shows numerical values when the phosphor layer having an average film density which falls within a range from 2.0 g/cm³ to 3.4 g/cm³ and a film thickness of 15 μm is operated at an acceleration voltage of 7 kV using the phosphor having the true density which falls within a range from 4.0 g/cm³ to 5.1 g/cm³. In FIG. 9, there is observed a tendency that when the particle size becomes a value smaller than 4 μm, the brightness ratio is sharply lowered and hence, the use of the phosphor shaving particle size smaller than 4 μm is not desirable.

On the other hand, the larger the particle size of the phosphor particles, the crystallinity is enhanced and hence, the phosphor particles having the particle size which falls within a range from 5 to 9 μm are used in the color cathode ray tube disclosed in the above-mentioned patent document 4. However, usually, the phosphor particles having the larger particle size of approximately 12 μm are used.

To the contrary, according to the present invention, the applied voltage is low compared to the applied voltage of the color cathode ray tube, for example, approximately 10 kV or less and hence, an electron beam incidence distance to the phosphor layer becomes short and the brightness becomes dependent on a specific surface area of phosphors. This implies that there exists a tendency that the smaller the particle size of the phosphor, it is advantageous for the brightness and it is desirable to set the maximum particle size to 9 μm or less from a viewpoint of crystallinity and the specific surface area.

Further, in view of the above-mentioned relationship between the number of stacked layers and the film thickness of the phosphor particles, when the particle size exceeds 9 μm, the lowering of the brightness is not avoided and hence, the particle size is set to a value which falls within a range from 4 μm to 9 μm, is preferably set to a value which falls within a range from 5 μm to 8 μm, still further a value which falls within a range from 6 μm to 7 μm from a viewpoint of practicality.

### Embodiment 2

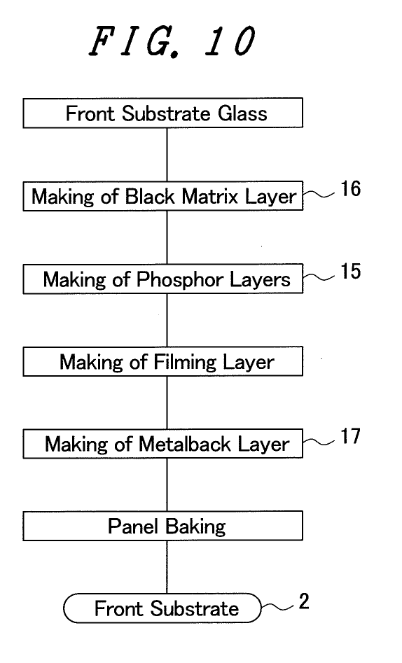

FIG. 10 is a flow chart for explaining a manufacturing method of a planar image display device of the present invention, wherein parts identical with the parts in the above-mentioned drawings are given same symbols. In FIG. 10, a black matrix (BM) film 16 is formed on a substrate glass of the face substrate 2. The BM film 16 includes a plurality of window portions 161 therein as shown in FIG. 4, for example. Next, phosphor layers 15 (15B, G, R) of three colors are formed on the BM film 16 in a predetermined pattern so as to cover the window portions 161 and also have a shape which extends to the outside. It is preferable to form the phosphor layers using screen printing.

Next, a filming film is formed so as to cover the phosphor layers 15 and the exposed BM film 16. The filming film is burnt out and removed in a later step.

Next, a metal back layer 17 is formed so as to cover the filming film. The metal back layer 17 has a property to allow electron beams to pass therethrough and a property to reflect light.

Next, panel baking is performed so as to burn out and eliminate the filming film thus forming a face substrate 2.

### COMPARISON EXAMPLE 1

In accordance with the steps shown in FIG. 10, first of all, on a face substrate glass, a BM film 12, a green phosphor layer 15G, a blue phosphor layer 15B, a red phosphor layer 15R, an organic leveling film and a metal back layer 17 are formed in this order. Parts ranging from the BM film to the organic leveling film can be formed by a conventionally known method. Here, although the explanation is made with respect to a 17-type glass substrate, the same goes for a glass substrate of other size.

First of all, a two-layered film consisting of a chromium oxide film having a film thickness of 50 nm and a metal chromium film having a film thickness of 200 nm is formed on the face glass substrate by a sputtering method. Thereafter, the two-layered film is patterned by photolithography thus forming the BM film 16 having the window portions 161.

Next, using a green phosphor paste which is formed by dispersing green phosphor ZnS: Cu, Al having an average particle size of 6 μm in a dispersion medium which is made of cellulosic resin and acetic acid 2-(2-n-butoxy ethoxy) ethyl by mill dispersion, a pattern of the green phosphor layer 15G is formed by a screen printing method.

In the same manner, a pattern of the blue phosphor layer 15B made of blue phosphor ZnS:Ag,Cl having an average particle size of 6 μm, and a pattern of the red phosphor layer 15R made of red phosphor Y₂O₂S:Eu having an average particle size of 6 μm are respectively formed by a screen printing method. Here, the film thicknesses of the phosphor layers are respectively set to 15 μm. Thereafter, ink made of an acryl/cellulose resin and a high-melting-point solvent is pattern-printed on only the phosphor layers 15, is dried thus forming an organic leveling film (filming film). Here, surface roughness of the filming film is set to Rz=10 μm.

A metal back layer is formed on the filming film. In forming the metal back layer, a conventionally known DC magnetron sputter method is used, wherein the metal back layer is formed using an aluminum target and an argon discharge gas. As the forming condition, a condition that the metal back layer having a film thickness of 100 nm is formed when films are stacked on a planar glass substrate at a lamination speed of 5 angstrom/S for 200 seconds is set.

Under such a condition, by applying a sputter film forming on a filming film having a surface roughness of 10 μm, a metal back layer 17 having an aluminum film thickness of 70 nm, an aluminum mass per unit area of 25 μg/cm², and a film density of 2.5 g/cm³ is obtained. Here, the film thickness is measured using S-5000 of FE-SEM (made by Hitachi Ltd) or mass per unit area is obtained by dissolving a metal back film in hydrochloric acid after being peeled off and, thereafter, by measuring the mass per unit area by an ICP spectro-photometry. Further, film density is obtained from calculation based on the film thickness and the mass per unit area.

Here, the reason that the aluminum film thickness is smaller than a thickness of a smoothed substrate at the time of setting the above-mentioned condition is that the surface area is increased due to the surface unevenness of the filming film. A fixed relationship is established between the surface roughness Rz and a surface area increase ration when the filming is completed. This implies that it is necessary to take a surface roughness of a background in setting a condition with the smoothing substrate into consideration. Further, an integral reflectance of the aluminum film exhibits the high reflection characteristic of 90% as a result of measurement using Spectrophotometer U-3300 (manufactured by Hitachi Ltd, an inner wall of an integral sphere being barium sulfate; reference being alumina).

On the other hand, with respect to the phosphor layer, organic materials in the phosphor film and the filming film are burnt out by panel baking, the phosphor film is peeled off, and an average film density obtained based on the film mass per unit area is 2.8 g/cm³. This film density is a value obtained by subtracting an amount corresponding to the aluminum film. A planar image display device is obtained by combining the face substrate which is provided with the phosphor screen having such a constitution and the back substrate having MIM-type electron sources.

On the other hand, for a comparison example, a planar image display device having the specification equal to the above-mentioned specification except for that the formation of the phosphor layer is performed using a slurry rotation coating method (average film density 1.9 g/cm³) is prepared, both devices are driven by applying a voltage of 7 kV and the brightness is measured. As a result, compared to the comparison display device which has the phosphor film of average film thickness of 1.9 g/cm³, the display device of the present invention can enhance the brightness thereof by 10% or more.

### COMPARISON EXAMPLE 2

Up to the formation of the BM film, the method is performed in accordance with the same specification as the comparison example 1. Subsequently, a green phosphor paste is formed by dispersing green phosphor Y₂SiO₅:Tb having average particle size of 4 μm in a dispersion medium which is made of cellulosic resin and acetic acid 2-(2-n-butoxyethoxy) ethyl by mill dispersion, and a pattern of the green phosphor layer 15G is formed by a screen printing method using the green phosphor paste. In the same manner, a pattern of the blue phosphor layer 15B is formed using the blue phosphor ZnS:Ag,Al, and a pattern of the red phosphor layer 15R is formed using the red phosphor Y₂O₃:Eu. Here, the respective phosphor films have a thickness of 11 μm.

Thereafter, ink which is made of acryl/cellulose resin and a high-boiling-point solvent is printed in accordance with a pattern only on the phosphor layer 15, is dried thus forming an organic smoothing film (a filming film). Here, the surface roughness Rz of the filming film is set to 7 μm. Thereafter, in the same manner as the comparison example 1, the formation of the metal back film and the panel baking is performed so as to form the face substrate which includes the phosphor film having the average film density of 3.2 g/cm³. A planar image display device is obtained by combining the face substrate which is provided with the phosphor screen having such a constitution and the back substrate having the MIM-type electron sources.

On the other hand, for a comparison example, a planar image display device having the specification equal to the above-mentioned specification except for that the formation of the phosphor layer is performed using a slurry rotation coating method (average film density 2.0 g/cm³) is prepared, both devices are driven by applying a voltage of 7 kV and the brightness is measured. As a result, compared to the comparison display device which has the phosphor film of average film density of 2.0 g/cm³, the display device of the present invention can enhance the brightness thereof by 15% or more.

### COMPARISON EXAMPLE 3

Up to the formation of the BM film, the method is performed in accordance with the same specification as the comparison example 1. Subsequently, a green phosphor paste is formed by dispersing green phosphor Y₂SiO₅:Tb having average particle size of 6 μm in a dispersion medium which is made of cellulosic resin and acetic acid 2-(2-n-butoxyethoxy) ethyl by mill dispersion. In the manufacture of the paste, the mill dispersion is performed more strongly than the comparison example 1. The pattern of the green phosphor layer 15G is performed by a screen printing method using the paste. In the same manner, a pattern of the blue phosphor layer 15B is formed using the blue phosphor ZnS:Ag,Al, and a pattern of the red phosphor layer 15R is formed using the red phosphor Y₂O₃:Eu. Here, the respective phosphor films have a thickness of 15 μm.

Thereafter, ink which is made of acryl/cellulose resin and a high-boiling-point solvent is imprinted in accordance with a pattern only on the phosphor layer 15, is dried thus forming an organic smoothing film (a filming film). Here, the surface roughness Rz of the filming film is set to 6 μm. Thereafter, in the same manner as the comparison example 1, the formation of the metal back film and the panel baking are performed thus forming the face substrate which includes the phosphor film having the average film density of 3.4 g/cm³. A planar image display device is obtained by combining the face substrate which is provided with the phosphor screen having such a constitution and the back substrate having the MIM-type electron sources.

On the other hand, for a comparison example, a planar image display device having the specification equal to the above-mentioned specification except for that the formation of the phosphor layer is performed using a slurry rotation coating method (average film density 1.9 g/cm³) is prepared, both devices are driven by applying a voltage of 7 kV and the brightness is measured. As a result, compared to the comparison display device which has the phosphor film of average film density of 1.9 g/cm³, the display device of the present invention can enhance the brightness thereof by 20% or more.

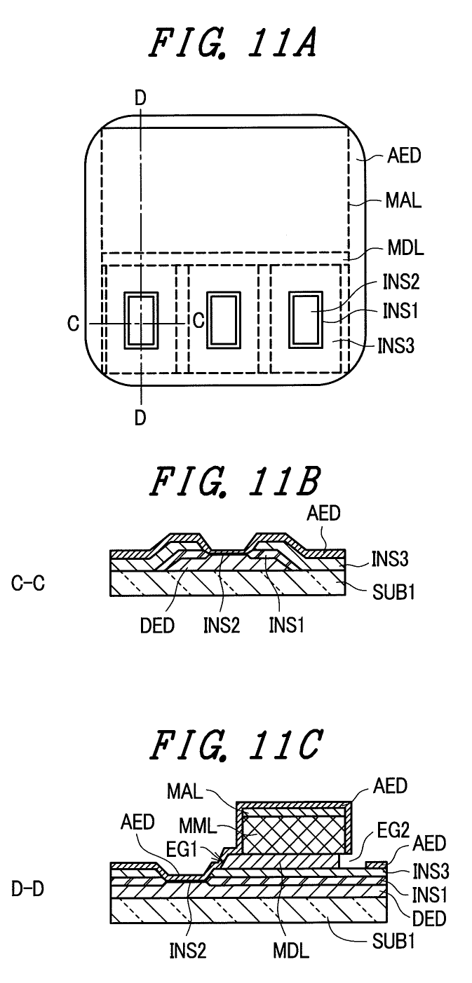

FIG. 11A, FIG. 11B and FIG. 11C are views for explaining an example of electron sources 10 which constitute pixels of the image display device of the present invention, wherein FIG. 11A is a plan view, FIG. 11B is a cross-sectional view taken along a line C-C in FIG. 11A, and FIG. 11C is a cross-sectional view taken along a line D-D in FIG. 11A. The electron sources are formed of an MIM electron source.

The structure of the electron source is explained in conjunction with manufacturing steps. First of all, on the back substrate SUB1, lower electrodes DED (the video signal lines 8 in the above-mentioned respective embodiments), a protective insulation layer INS1, an insulation layer INS2 are formed. Next, an interlayer insulation film INS3, upper bus electrodes (the scanning signal lines 9 in the above-mentioned embodiment) which become electricity supply lines to upper electrodes AED, and a metal film which constitutes a spacer electrode for arranging spacers 12 are formed by a sputtering method, for example.

The interlayer insulation film INS3 may be made of silicon oxide, silicon nitride, silicon or the like, for example. Here, the interlayer insulation film INS3 is made of silicon nitride film and has a film thickness of approximately 100 nm. The interlayer insulation film INS3, when a pin hole is formed in a protective insulation layer INS1 formed by anodizing, fills a void and plays a role of ensuring the insulation between a lower electrode DED and an upper bus electrode which constitutes a scanning signal line 9 {a three-layered laminated film which sandwiches cupper (Cu) which constitutes a metal film intermediate layer MML between a metal film lower layer MDL and a metal film upper layer MAL}.

Here, the upper bus electrode which constitutes the scanning signal line 9 is not limited to the above-mentioned three-layer laminated film and the number of layers may be increased more. For example, the metal film lower layer MDL and the metal film upper layer MAL may be made of a metal material having high oxidation resistance such as aluminum (Al), chromium (Cr), tungsten (W), molybdenum (Mo) or the like, an alloy containing such metal, or a laminated film of these metals. Here, the metal film lower layer MDL and the metal film upper layer MAL are made of an alloy of Al—Nd. In addition to the alloy, with the use of a five-layered film in which the metal film lower layer MDL is a laminated film formed of an Al alloy and Cr, W, MO or the like, the metal film upper layer MAL is a laminated film formed of Cr, W, Mo or the like and an Al alloy, and films which are brought into contact with the metal film intermediate layer MML made of Cu are made of a high-melting-point metal, in a heating step of a manufacturing process of the planar image display device, the high-melting-point metal functions as a barrier film thus preventing Al and Cu from being alloyed whereby the five-layered film is particularly effective in the reduction of resistance.

When the metal film lower layer MDL and the metal film upper layer MAL are made of only Al—Nd alloy, a film thickness of the Al—Nd alloy in the metal film upper layer MAL is larger than a film thickness of the Al—Nd alloy in the metal film lower layer MDL, and a thickness of Cu of the metal film intermediate layer MML is made as large as possible to reduce the wiring resistance. Here, the film thickness of the metal film lower layer MDL is 300 nm, the film thickness of the metal film intermediate layer MML is 4 μm, and the film thickness of the metal film upper layer MAL is 450 nm. Here, Cu in the metal film intermediate layer MML can be formed by electrolytic plating or the like in addition to sputtering.

With respect to the above-mentioned five-layered film which uses high-melting-point metal, in the same manner as Cu, it is particularly effective to use a laminated film which sandwiches Cu with Mo which can be etched by wet etching in a mixed aqueous solution of phosphoric acid, acetic acid and nitric acid as the metal film intermediate layer MML. In this case, a film thickness of Mo which sandwiches Cu is set to 50 nm, a film thickness of the Al alloy of the metal film lower layer MDL which sandwiches the metal film intermediate layer MML together with the metal film upper layer MAL is 300 nm, and the film thickness of the Al alloy of the metal film upper layer MAL which sandwiches the metal film intermediate layer MML together with the metal film lower layer MDL is 50 nm.

Subsequently, the metal film upper layer MAL is formed in a stripe shape which intersects the lower electrode DED by performing the patterning of resist by screen printing and etching. The etching is performed by wet etching using a mixed aqueous solution of phosphoric acid and acetic acid, for example. By excluding the nitric acid from the etchant, it is possible to selectively etch only the Al—Nd alloy without etching Cu.

Also in case of the five-layered film which uses Mo, by excluding the nitric acid from the etchant, it is possible to selectively etch only the Al—Nd alloy without etching Mo and Cu. Here, although one metal film upper layer MAL is formed per one pixel, two metal film upper layers MAL may be formed per pixel.

Subsequently, by using the same resist film directly or using the Al—Nd alloy of the metal film upper layer MAL as a mask, Cu of the metal film intermediate layer MML is etched by wet etching using a mixed aqueous solution of phosphoric acid, acetic acid and nitric acid, for example. Since an etching speed of Cu in the etchant made of mixed aqueous solution of phosphoric acid, acetic acid and nitric acid is sufficiently fast compared to an etching speed of the Al—Nd alloy and hence, it is possible to selectively etch only Cu of the metal film intermediate layer MML. Also in case of the five-layered film which uses Mo, the etching speeds of Mo and Cu are sufficiently fast compared to an etching speed of the Al—Nd alloy and hence, it is possible to selectively etch only the three-layered film made of Mo and Cu. In etching Cu, in addition to the above-mentioned aqueous solution, an ammonium persulfate aqueous solution, a sodium persulfate solution can be effectively used.

Subsequently, the metal film lower layer MDL is formed in a stripe shape which intersects the lower electrode DED by performing the patterning of resist by screen printing and etching. The etching is performed by wet etching using a mixed aqueous solution of phosphoric acid and acetic acid. Here, by displacing the position of the printing resist film from the stripe electrode of the metal film upper layer MAL in the parallel direction, one-side EG1 of the metal film lower layer MDL projects from the metal film upper layer MAL thus forming a contact portion to ensure the connection with the upper electrode AED in a later stage. On the opposite side EG2 of the metal film lower layer MDL, using the metal film upper layer MAL and the metal film intermediate layer MML as masks, the over-etching is performed and hence, a retracting portion is formed on the metal film intermediate layer MML as if eaves are formed.

Due to the eaves of the metal film intermediate layer MML, the upper electrode AED which is formed as a film in a later step is separated. Here, when the film thickness of the metal film upper layer MAL is set larger than the film thickness of the metal film lower layer MDL, even when the etching of the metal film lower layer MDL is finished, it is possible to allow the metal film upper layer MAL to remain on Cu of the metal film intermediate layer MML. Due to such a constitution, it is possible to protect a surface of Cu with the metal film upper layer MAL and hence, it is possible to ensure the oxidation resistance even when Cu is used. Further, it is possible to separate the upper electrode AED in a self-aligning manner and it is possible to form the upper bus electrodes which constitute scanning signal lines which perform the supply of electricity. Further, in case that the metal film intermediate layer MML is formed of the five-layered film which sandwiches Cu with Mo, even when the Al alloy of the metal film upper layer MAL is thin, Mo suppresses the oxidation of Cu and hence, it is not always necessary to make the film thickness of the metal film upper layer MAL larger than the film thickness of the metal film lower layer MDL.

Subsequently, electron emitting portions are formed as openings in the interlayer film INS3. The electron emitting portion is formed in a portion of an intersecting portion of a space which is sandwiched by one lower electrode DED inside the pixel and two upper bus electrodes (a laminated film consisting of a metal film lower layer MDL, a metal film intermediate layer MML, a metal film upper layer MAL and a laminated film consisting of a metal film lower layer MDL, a metal film intermediate layer MML, a metal film upper layer MAL of neighboring pixel not shown in the drawing) which intersect the lower electrode DED. The etching is performed by dry etching which uses an etching gas containing CF₄ and SF₆ as main components, for example.

Finally, the upper electrode AED is formed as a film. The upper electrode AED is formed by a sputtering method. The upper electrode AED may be made of aluminum or a laminated film made of Ir, Pt and Au, wherein a film thickness may be 6 nm, for example. Here, the upper electrode AED is, at one portion (right side in FIG. 11C) of two upper bus electrodes (a laminated film consisting of a metal film lower layer MDL, a metal film intermediate layer MML and a metal film upper layer MAL) which sandwich the electron emitting portions, cut by a retracting portion (EG2) of the metal film lower layer MDL formed by the eaves structure of the metal film intermediate layer MML and the metal film upper layer MAL. Then, at another portion (left side in FIG. 11C) of the upper bus electrodes, the upper electrode AED is formed and is connected with the upper bus electrode (the laminated film consisting of the metal film lower layer MDL, the metal film intermediate layer MML and the metal film upper layer MAL) by a contact portion (EG1) of the metal film lower layer MDL without causing a disconnection thus providing the structure which supplies electricity to the electron emitting portions.

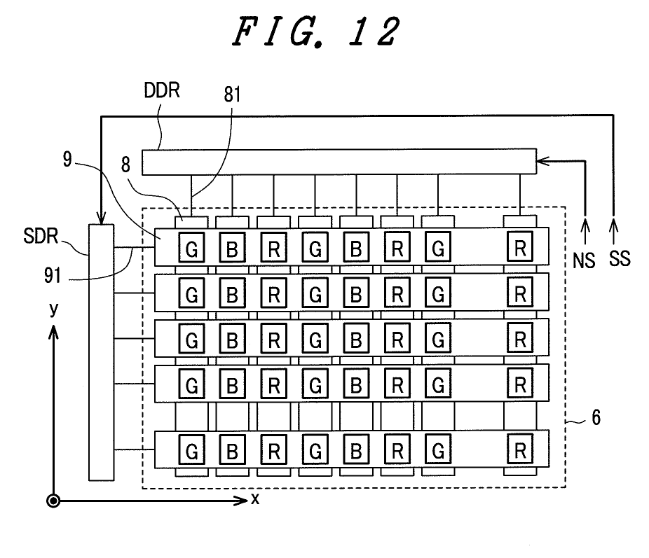

FIG. 12 is an explanatory view of an example of an equivalent circuit of a planar image display device to which the constitution of the present invention is applied. A region depicted by a broken line in FIG. 12 indicates a display region. On the back substrate which corresponds to the display region, n pieces of video signal lines 8 and m pieces of scanning signal lines 9 are arranged in a state that these lines intersect each other thus forming matrix of n×m. The respective intersecting portions of the matrix correspond to the sub pixels. One group consisting of three unit pixels (or sub pixels) “R”, “G”, “B” in the drawing constitutes one color pixel. Here, the constitution of the electron sources is omitted from the drawing. The video signal lines (cathode lines) 8 are connected to the video signal drive circuit DDR through the video signal line lead terminals 81, while the scanning signal lines (gate lines) 9 are connected to the scanning signal drive circuit SDR through the scanning signal line lead terminal 91. The video signal NS is inputted to the video signal drive circuit DDR from an external signal source, while the scanning signal SS is inputted to the scanning signal drive circuit SDR in the same manner.

Due to such a constitution, by supplying the video signal to the video signal lines 8 which intersect the scanning signal lines 9 which are sequentially selected, it is possible to display a two-dimensional full color image.

What is claimed is:

1. A planar image display device comprising:
a back substrate which includes a plurality of first lines which extends in the first direction and is arranged in parallel in the second direction which intersects the first direction, an insulation film which is formed in a state that the insulation film covers the first lines, a plurality of second lines which extends in the second direction and is arranged in parallel in the first direction on the insulation film, and electron sources which are arranged in the vicinity of the intersection portions of the first lines and the second lines and are connected to the first lines and the second lines;
a face substrate which is arranged in a state that the face substrate faces the back substrate in an opposed manner with a predetermined interval therebetween, a black matrix film which is arranged on an inner surface of the face substrate and has a plurality of window portions, a phosphor layer arranged in a state that the phosphor layer covers the plurality of window portions of the black matrix film, a metal back layer which covers the phosphor layer;
a frame body which is interposed between the back substrate and the face substrate in a state that the frame body surrounds a display region and holds the predetermined distance; and
a sealing material which hermetically seals end surfaces of the frame body and at least one of the face substrate and the back substrate to each other, wherein
an average film density of the phosphor layer is set to a value which falls within a range from 2.0 g/cm³ to 3.4 g/cm³.

2. A planar image display device according to claim 1, wherein an average particle size of phosphor particles in the phosphor layer is set to a value which falls within a range from 4 μm to 9 μm.

3. A planar image display device according to claim 1, wherein an average particle size of phosphor particles in the phosphor layer is set to a value which falls within a range from 5 μm to 8 μm.

4. A planar image display device according to claim 1, wherein an average particle size of phosphor particles in the phosphor layer is set to a value which falls within a range from 6 μm to 7 μm.

5. A planar image display device according to claim 1, wherein a thickness of the phosphor layer is set to a value 1.8 to 3.0 times as large as the average particle size of the phosphor particle.

6. A planar image display device according to claim 1, wherein a thickness of the phosphor layer is set to a value which falls within a range from 10 μm to 20 μm.

7. A planar image display device according to claim 1, wherein true density of the phosphor particles in the phosphor layer is set to a value which falls within a range from 4.0 g/cm³ to 5.1 g/cm³.

8. A planar image display device according to claim 1, wherein the electron source is formed of a thin-film-type electron source array which includes a lower electrode, an upper electrode and an electron acceleration layer which is sandwiched between the lower electrode and the upper electrode, and emits electrons from the upper electrode when a voltage is applied between the lower electrode and the upper electrode.

9. A planar image display device according to claim 1, wherein the electron source is constituted of an electron emitting element which includes a conductive film having an electron emitting portion.

10. A planar image display device according to claim 1, wherein the electron source is formed of at least carbon nanotubes.

11. A manufacturing method of a planar image display device comprising:
a back substrate which includes a plurality of first lines which extends in the first direction and is arranged in parallel in the second direction which intersects the first direction, an insulation film which is formed in a state that the insulation film covers the first lines, a plurality of second lines which extends in the second direction and is arranged in parallel in the first direction on the insulation film, and electron sources which are arranged in the vicinity of the intersection portions of the first lines and the second lines and are connected to the first lines and the second lines;
a face substrate which is arranged in a state that the face substrate faces the back substrate in an opposed manner with a predetermined interval therebetween, a black matrix film which is arranged on an inner surface of the face substrate and has a plurality of window portions, a phosphor layer arranged in a state that the phosphor layer covers the plurality of window portions of the black matrix film, a metal back layer which covers the phosphor layer,
a frame body which is interposed between the back substrate and the face substrate in a state that the frame body surrounds a display region and holds the predetermined distance; and
a sealing material which hermetically seals end surfaces of the frame body and at least one of the face substrate and the back substrate to each other, wherein
the manufacturing method of the planar image display device includes a step for forming the phosphor layer using a phosphor paste including phosphor particles having an average particle size which falls within a range from 4 μm to 9 μm and true density which falls within a range from 4.0 g/cm³ to 5.1 g/cm³ by screen printing.
